(19) United States
(12) Patent Application Publication
(10) Pub. No.: US 2025/0071631 A1
(43) Pub. Date: Feb. 27, 2025

(54) FAST PSCELL ACCESS FOR IMPROVED USER THROUGHPUT

(71) Applicant: Nokia Technologies Oy, Espoo (FI)

(72) Inventors: Halit Murat GÜRSU, Munich (DE); Umur KARABULUT, Munich (DE); Dariusz PALKA, Krakow (PL); Xin ZHANG, Munich (DE); Riikka Karoliina DIMNIK, Espoo (FI); Jani-Pekka KAINULAINEN, Cambridge (GB)

(21) Appl. No.: 18/807,107

(22) Filed: Aug. 16, 2024

(30) Foreign Application Priority Data
Aug. 21, 2023 (GB) 2312732.7

(51) Int. Cl. H04W 36/00

(52) U.S. Cl. CPC H04W 36/0064; H04W 36/0083

(57) ABSTRACT

An apparatus comprising means for sending a response to the first target master node based on the received first request in response to receiving a first secondary node addition request for the user equipment from a first target master node, means for sending a response to the second target master node based on the received second request in response to receiving a second secondary node addition request from a second target master node for the same user equipment; and means for enabling, in response to receiving a physical uplink shared channel message from the user equipment, decoding of the physical uplink shared channel message received from the user equipment based on a first target master node key associated with the first target master node in case no information is available whether user equipment accessed first or second target master node, and, if decoding with the first key not successful, decoding based on a second target master node key associated with the second target master node.

### TECHNICAL FIELD

The present invention relates to fast access to a primary cell of a secondary cell group (PSCell) for improved user throughput.

### BACKGROUND

A conditional handover (CHO) is a feature supported in LTE (Long Term Evolution) and in 5G NR (New Radio). The CHO resembles in many aspects the previously known “ordinary” handover (HO), i.e. the legacy HO. As a main difference to the legacy HO, in the CHO the user equipment (UE) starts the preparations for handover to the target node only when an additional CHO execution condition is met. Another difference between the legacy HO and the CHO is the preparation of multiple target cells in the CHO. Thus, the CHO reserves more resources at target cells than a legacy HO while waiting for the execution.

In multi-radio dual connectivity (MR-DC) the CHO is a limited to a scenario where a target master node (MN) can prepare a single target PSCell, under the control of a secondary node (SN). This may limit the usefulness of the CHO MR-DC feature where a UE may need to access a different target PSCell while the CHO needs to be executed. A mechanism is under development for CHO in MR-DC where a target MN can prepare multiple target PSCells for the same target PCell. A focus is to provide a configuration to a UE which consist of both a conditional handover configuration and a conditional PSCell addition or change (CPAC) configuration. In other words, a UE will perform conditional handover to both PCell and PSCell, considering the execution conditions of each cell given in the handover configuration.

The UE evaluates CHO and CPC conditions in parallel and the UE executes CHO+CPC configuration only if both conditions are met. However, the order of sending the random-access message to target PCell and target PSCell is not defined.

### SUMMARY

The UE may, e.g. by implementation or (remote) configuration, e.g. by a serving node, may be enabled to transmit target PCell random-access preamble and target PSCell random-access preamble one before another, or may be configured to send the target PCell random-access preamble before the target PSCell random-access preamble, or to send the target PSCell random-access preamble only after completion of the access to the target PCell, or else.

In case the SN random-access is triggered before the MN random-access, security issues may arise, leading to target PSCell random-access failure and enabling phishing attacks.

If the SN random-access is triggered before the MN random-access, following problems may arise:

The UE can be configured with multiple conditional dual connectivity configurations over different target MNs. Each dual connectivity configuration has a separate security key for the configuration of SN terminated bearers. To save resources, the target SN may allocate the same preamble for different CHO configurations as it will be used by the same UE. Therefore, the target SN may not be able to identify the UE after the reception of the random-access preamble. In other words, the preamble cannot be used to determine the security key. This will lead to target PSCell random-access failure, e.g. the target SN will not send any RAR (Random Access Response) message, the UE will not receive any RAR message and after a RAR timer expires at the UE, a PSCell access failure may be detected, or the UE may be configured to resend preamble, which may lead to another failure or delay, e.g. if the UE has accessed the target MN successfully in the meantime and access completion info was sent from the target MN to the target SN, the target SN may then know the selected target MN and be able to identify the target MN and respond to the UE with RAR message.

Another problem is that to identify itself at Contention based Random-Access (CBRA) procedure, the UE indicates a C-RNTI (cell Radio Network Temporal Identifier) to a network. Receiving the C-RNTI, the network matches this to the configurations provided. However, C-RNTI is not a security protected signal, and any UE can indicate the C-RNTI of the UE to replicate the configured UE. This is normally resolved by the UE using a secured RRC (Radio Resource Control) message towards the target MN and target MN forwarding the same message to the target SN, but currently the target SN does not indicate any secure control message to complete the access procedure in dual connectivity handover. Therefore, to determine the security key to be used solely depending on C-RNTI, creates exposure to phishing attacks.

Now, in an exemplary embodiment, an improved method and technical equipment implementing the method has been invented, by which at least one of the above problems are alleviated and/or addressed. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to an embodiment, one or more of the problems are solved by indicating by a UE that it supports the enhanced dual connectivity handover execution procedure, e.g., via UE capability signaling. Since the allocated preamble cannot be used to determine the security key, the target SN employs blind decoding of a UE Physical Uplink Shared Channel (PUSCH) r message, in other words, the network sends a random-access response to the UE as it employs blind decoding of UE PUSCH message through multiple security keys configured for the UE. The target SN has a list of keys configured for the UEs and tries to decode the message received from a UE, using the list of keys, and see if any of the keys result in successful decrypting of the message received. If any key results in successful decrypting of the message received, the target SN may determine that the UE for which that key is associated with, is the correct UE. The UE may be configured with tight requirements to complete the dual connectivity handover procedure faster than previously to decrease the interruption time and maximize UE throughput.

Instead of the CBRA procedure, a Contention free Random-Access (CFRA) procedure may be used, wherein the UE allocates CFRA preambles to avoid the issue that can be raised with CBRA preambles. Secondary Cell Group (SCG) configurations for a certain target secondary node (T-SN) contain the same CFRA resources configured for the UE.

In another option, the network increases the random-access response timer to allow waiting for a large time in order to be able to receive the rrc reconfiguration complete message from target MN.

According to another embodiment, one or more of the problems are solved by performing the random-access procedure for the PCell first or at the same time with PSCell. In other words, the UE may not be allowed to initiate random-access towards the target PSCell unless the target PCell random-access is successfully completed, the UE may initiate the PCell random-access before or at the same time to the PSCell RA, and a target cell Pcell random-access is performed before PSCell and “at the same time” is defined as a window where Pcell and PSCell access is executed within. In other words, “at the same time” does not necessarily mean exactly the same time but within the defined time window.

According to still another embodiment, one or more of the problems are solved so that the UE is allowed to complete RA procedure at a target PSCell, but possible data traffic is put on hold at RAN level until the target the PSCell receives a SN-dedicated RRCReconfigurationComplete message forwarded by the target PCell.

According to yet another embodiment, one or more of the problems are solved so that the UE sends a secured control message directly to the target SN with its configured security key to confirm the completion of the random-access procedure.

According to a first aspect, there is provided a user equipment comprising:
means for indicating a conditional handover capability towards a serving network node, wherein the capability includes information whether the user equipment supports accessing a primary cell of a target secondary node prior to or in parallel to accessing a primary cell of a target master node;
means for initiating a conditional handover execution in response to receiving a conditional handover configuration for a primary cell of a first target master node and a primary cell of a first secondary node, and another conditional handover configuration for a primary cell of a second target master node and the primary secondary cell of the first secondary node, when the conditional handover configuration for a certain target master node and the target secondary node holds; and
means for accessing the primary cell of the target secondary node prior to or in parallel to accessing the primary cell of the certain target master node in case the capability is enabled.

A user equipment according to a second aspect comprises at least one processor and at least one memory, said at least one memory stored with computer program code thereon, the at least one memory and the computer program code configured to, with the at least one processor, cause the user equipment at least to perform:
indicating a conditional handover capability towards a serving network node, wherein the capability includes information whether the user equipment supports accessing a primary cell of a target secondary node prior to or in parallel to accessing a primary cell of a target master node;
in response to receiving a conditional handover configuration for a primary cell of a first target master node and a primary cell of a first secondary node, and another conditional handover configuration for a primary cell of a second target master node and the primary secondary cell of the first secondary node;
initiating a conditional handover execution, when the conditional handover configuration for a certain target master node and the target secondary node holds; and
accessing the primary cell of the target secondary node prior to or in parallel to accessing the primary cell of the certain target master node in case the capability is enabled.

A method according to a third aspect comprises:
indicating a conditional handover capability towards a serving network node, wherein the capability includes information whether the user equipment supports accessing a primary cell of a target secondary node prior to or in parallel to accessing a primary cell of a target master node;
in response to receiving a conditional handover configuration for a primary cell of a first target master node and a primary cell of a first secondary node, and another conditional handover configuration for a primary cell of a second target master node and the primary secondary cell of the first secondary node;
initiating a conditional handover execution, when the conditional handover configuration for a certain target master node and the target secondary node holds; and
accessing the primary cell of the target secondary node prior to or in parallel to accessing the primary cell of the certain target master node in case the capability is enabled.

A network node according to a fourth aspect comprises:
means for sending a response to the first target master node based on the received first request in response to receiving a first secondary node addition request for the user equipment from a first target master node;
means for sending a response to the second target master node based on the received second request in response to receiving a second secondary node addition request from a second target master node for the same user equipment; and
means for enabling, in response to receiving a physical uplink shared channel message from the user equipment, decoding of the physical uplink shared channel message received from the user equipment based on a first target master node key associated with the first target master node in case no information is available whether user equipment accessed first or second target master node, and, if decoding with the first key not successful, decoding based on a second target master node key associated with the second target master node.

A network node according to a fifth aspect comprises at least one processor and at least one memory, said at least one memory stored with computer program code thereon, the at least one memory and the computer program code configured to, with the at least one processor, cause the network node at least to perform:
in response to receiving a first secondary node addition request for the user equipment from a first target master node, sending a response to the first target master node based on the received first request;
in response to receiving a second secondary node addition request from a second target master node for the same user equipment, sending a response to the second target master node based on the received second request; and
in response to receiving a physical uplink shared channel message from the user equipment enabling, in case no information is available whether user equipment accessed first or second target master node, decoding of the physical uplink shared channel message received from the user equipment based on a first target master node key associated with the first target master node and, if decoding with the first key not successful, based on a second target master node key associated with the second target master node.

A method according to a sixth aspect comprises
in response to receiving a first secondary node addition request for the user equipment from a first target master node, sending a response to the first target master node based on the received first request;
in response to receiving a second secondary node addition request from a second target master node for the same user equipment, sending a response to the second target master node based on the received second request; and
in response to receiving a physical uplink shared channel message from the user equipment enabling, in case no information is available whether user equipment accessed first or second target master node, decoding of the physical uplink shared channel message received from the user equipment based on a first target master node key associated with the first target master node and, if decoding with the first key not successful, based on a second target master node key associated with the second target master node.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of a user equipment apparatus for incorporating functionalities for implementing various embodiments;

FIG. 2 shows schematically a layout of a user equipment apparatus according to an example embodiment;

FIG. 3 shows a part of an exemplifying radio access network;

FIG. 4 shows a signalling diagram for a conditional handover process;

FIG. 5 illustrates a signalling diagram according to an example embodiment;

FIG. 6 illustrates a signalling diagram according to another example embodiment;

FIG. 7 illustrates a signalling diagram according to yet another example embodiment;

FIG. 8a illustrates a signalling diagram according to still another example embodiment, based on a CFRA procedure;

FIG. 8a illustrates a signalling diagram according to still another example embodiment, based on a CBRA procedure;

FIG. 9 illustrates a signalling diagram according to a further example embodiment;

FIG. 10a shows a flow chart for a method in view of a UE according to an embodiment;

FIG. 10b shows a flow chart for a method in view of a target SN according to an embodiment; and

FIG. 11 shows a simplified block diagram of a network node according to an embodiment.

### DETAILED DESCRIPTION OF SOME EXAMPLE EMBODIMENTS

The following describes in further detail suitable apparatus and possible mechanisms carrying out the operations for a conditional handover. While the following focuses on 5G networks, the embodiments as described further below are by no means limited to be implemented in said networks only, but they are applicable in any network supporting conditional handover.

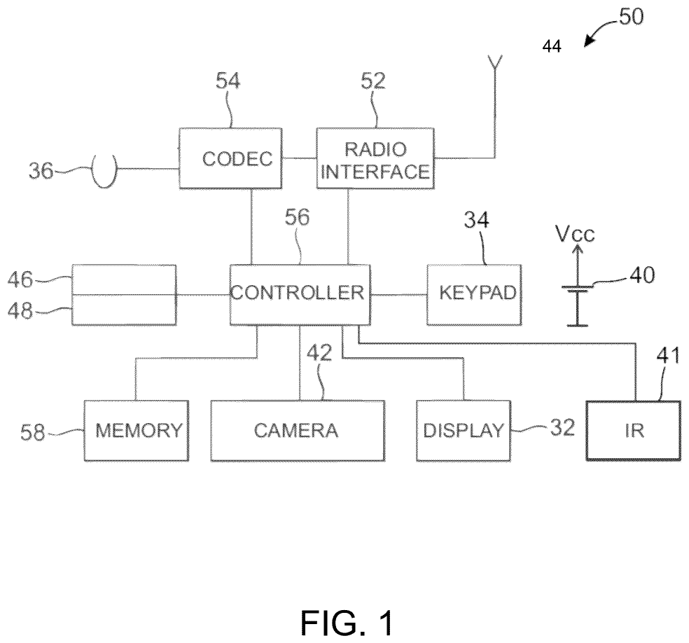

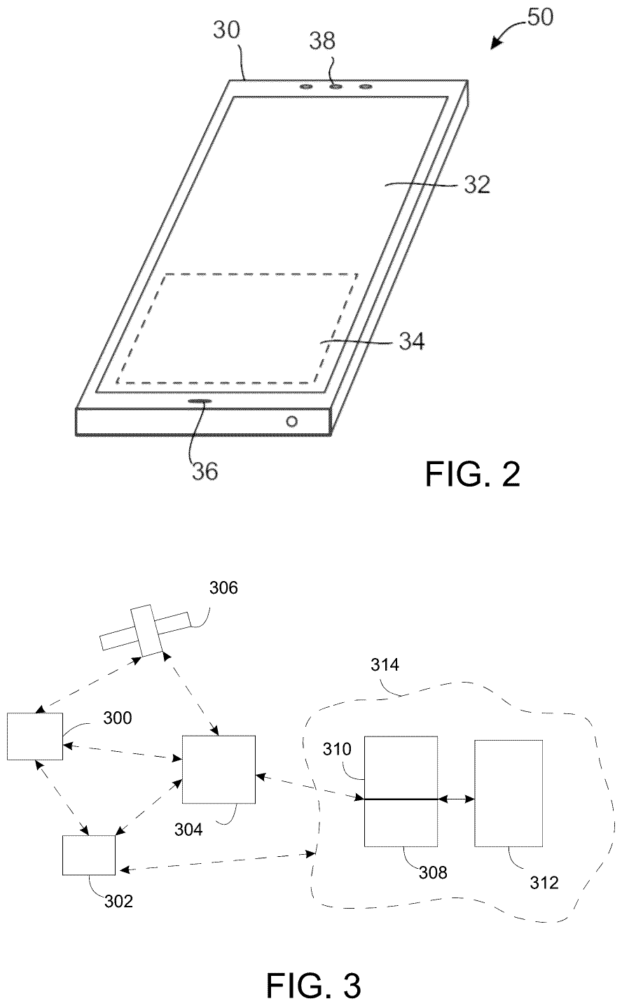

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and a gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as gNodeB) 304 providing the cell. The physical link from a user device to a gNodeB is called uplink or reverse link and the physical link from the gNodeB to the user device is called downlink or forward link. It should be appreciated that gNodeBs or their functionalities may be implemented by using any node (such as Integrated Access and Backhaul (IAB) node), host, server or access point etc. entity suitable for such a usage.

A communication system typically comprises more than one gNodeB in which case the gNodeBs may also be configured to communicate with one another over links, wired or wireless, designed for the purpose. These links may be used for signaling purposes. The gNodeB is a computing device configured to control the radio resources of communication system it is coupled to. The NodeB may also be referred to as a base station, an access point or any other type of interfacing device including a relay station capable of operating in a wireless environment. The gNodeB includes or is coupled to transceivers. From the transceivers of the gNodeB, a connection is provided to an antenna unit that establishes bi-directional radio links to user devices. The antenna unit may comprise a plurality of antennas or antenna elements. The gNodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

In 5G NR, the User Plane Function (UPF) may be used to separate the control plane and the user plane functions. Therein, the Packet Gateway (PGW) control and user plane functions may be decoupled, whereby the data forwarding component (PGW-U) may be decentralized, while the PGW-related signaling (PGW-C) remains in the core. This allows packet processing and traffic aggregation to be performed closer to the network edge, increasing bandwidth efficiencies while reducing network load.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHZ-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and non-real time functions being carried out in a centralized manner (in a centralized unit, CU 308).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of gNodeBs, the user device may have an access to a plurality of radio cells and the system may comprise also other apparatuses, such as physical layer relay nodes or other network elements, etc. At least one of the gNodeBs or may be a Home gnodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The gNodeBs of FIG. 1 may provide any kind of these cells. A cellular radio system may be implemented as a multilayer network including several kinds of cells. Typically, in multilayer networks, one access node provides one kind of a cell or cells, and thus a plurality of gNodeBs are required to provide such a network structure.

The Radio Resource Control (RRC) protocol is used in various wireless communication systems for defining the air interface between the UE and a base station, such as a gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states are controlled by a state machine of the RRC. When the UE is powered up, it is in a disconnected mode/idle mode. The UE may transit to RRC connected mode with an initial attach or with a connection establishment. If there is no activity from the UE for a short time, the gNB may suspend its session by moving to RRC Inactive mode and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ (Hybrid Automatic Repeat reQuest) feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random-access.

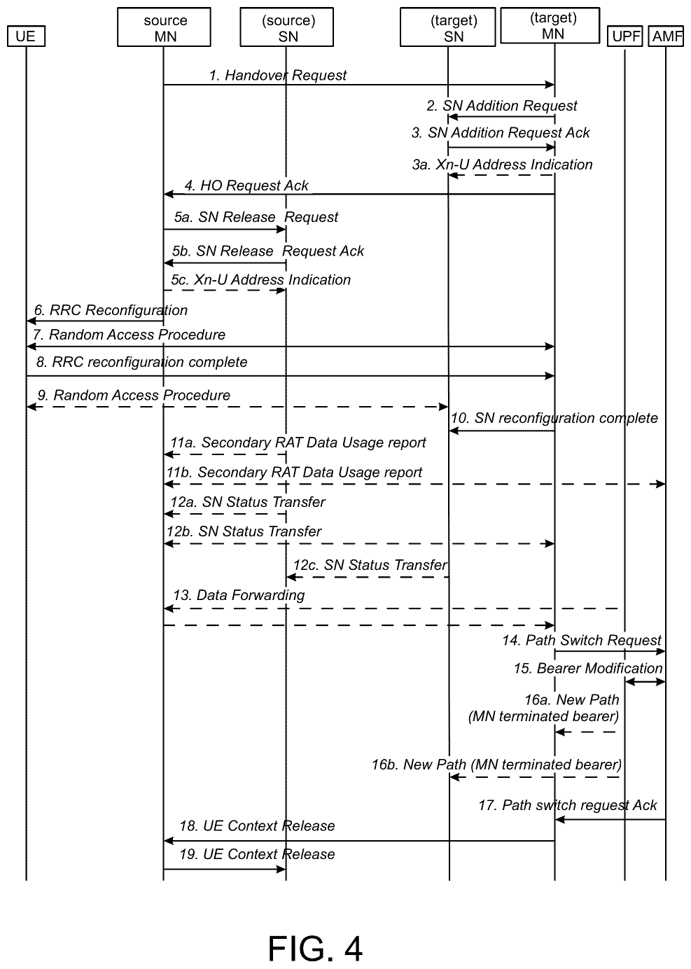

A conditional handover (CHO) is a feature supported in LTE and in 5G NR. The CHO resembles in many aspects the previously known “ordinary” handover (HO), i.e. the legacy HO. FIG. 4 illustrates an Inter-MN handover with/without MN initiated SN change in accordance with an example presented in TS 137 340 V 17.5.0. Such Inter-MN handover may be used to transfer UE context data from a source MN to a target MN while the UE context at the SN is kept or moved to another SN. During the handover, the target MN decides whether to keep, change the SN or release the SN.

At step 1, the source MN starts the handover procedure by initiating the Xn Handover Preparation procedure including both MCG and SCG configuration. The source MN includes the source SN UE XnAP ID, SN ID and the UE context in the source SN in the Handover Request message.

At step 2, if the target MN decides to keep the UE context in the source SN, the target MN sends SN Addition Request to the SN including the SN UE XnAP ID as a reference to the UE context in the SN that was established by the source MN. On the other hand, if the target MN decides to change the SN allowing delta configuration, the target MN sends the SN Addition Request to the target SN including the UE context in the source SN that was established by the source MN. Otherwise, the target MN may send the SN Addition Request to the target SN including neither the SN UE XnAP ID nor the UE context in the source SN that was established by the source MN.

In the following, the expression the (target) SN means either the original SN in the case that the target MN decides to keep the UE context in the source SN, or the new target SN in the case that the target MN decides not to keep the UE context in the source SN but selects another SN as the target SN. Similarly, the expression the (source) SN means either the original SN in the case that the target MN decides to keep the UE context in the source SN, or the new target (and source) SN in the case that the target MN decides not to keep the UE context in the source SN but selects another SN as the target SN.

At step 3, the (target) SN replies with SN Addition Request Acknowledge. The (target) SN may include the indication of the full or delta RRC configuration.

At step 3a, for SN terminated bearers using MCG resources, the target MN provides Xn-U DL TNL address information in the Xn-U Address Indication message.

At step 4, the target MN includes within the Handover Request Acknowledge message the MN RRC reconfiguration message to be sent to the UE in order to perform the handover, and may also provide forwarding addresses to the source MN. If PDU session split is performed in the target side during handover procedure, more than one data forwarding addresses corresponding to each node are included in the Handover Request Acknowledge message. The target MN indicates to the source MN that the UE context in the SN is kept if the target MN and the SN decided to keep the UE context in the SN in step 2 and step 3.

At step 5a/5b, the source MN sends a SN Release Request message to the (source) SN including a Cause indicating MCG mobility. The (source) SN acknowledges the release request. The source MN indicates to the (source) SN that the UE context in SN is kept, if it receives the indication from the target MN. If the indication as the UE context kept in SN is included, the SN keeps the UE context.

At step 5c, the source MN sends an XN-U Address Indication message to the (source) SN to transfer data forwarding information. More than one data forwarding addresses may be provided if the PDU session is split in the target side.

At step 6, the source MN triggers the UE to perform handover and apply the new configuration.

At step 7/8, the UE synchronizes to the target MN and replies with MN RRC reconfiguration complete message.

At step 9, if configured with bearers requiring SCG radio resources, the UE synchronizes to the (target) SN.

It should be noted that the order the UE performs Random-access towards the MN (step 7) and performs the random-access procedure towards the SN (step 9) is not defined.

At step 10, if the RRC connection reconfiguration procedure was successful, the target MN informs the (target) SN via SN Reconfiguration Complete message.

At step 11a, the source SN sends the Secondary RAT Data Usage Report message to the source MN and includes the data volumes delivered to and received from the UE over the NR/E-UTRA radio as described in clause 10.11.2. The order the source SN sends the Secondary RAT Data Usage Report message and performs data forwarding with MN/target SN is not defined. The SN may send the report when the transmission of the related QoS is stopped.

At step 11b, the source MN sends the Secondary RAT Report message to AMF to provide information on the used NR/EUTRA resource.

At step 12, for bearers using RLC AM, the source MN sends the SN Status Transfer to the target MN, including, if needed, SN Status received from the source SN. The target forwards the SN Status to the target SN, if needed.

At step 13, if applicable, data forwarding takes place from the source side. If the SN is kept, data forwarding may be omitted for SN terminated bearers or QoS flows kept in the SN.

At step 14-17, the target MN initiates the Path Switch procedure. If the target MN includes multiple DL TEIDs for one PDU session in the Path Switch Request message, multiple UL TEID of the UPF for the PDU session should be included in the Path Switch Ack message in case there is TEID update in UPF. If new UL TEIDs of the UPF for SN are included, the target MN performs MN initiated SN Modification procedure to provide them to the SN.

At step 18, the target MN initiates the UE Context Release procedure towards the source MN.

At step 19, upon reception of the UE Context Release message from source MN, the (source) SN releases C-plane related resources associated to the UE context towards the source MN. Any ongoing data forwarding may continue. The SN shall not release the UE context associated with the target MN if the UE contest kept indication was included in the SN Release Request message in step 5.

Dual Connectivity (DC) is a feature supported in LTE and in 5G NR enabling aggregation of two radio links at the PDCP (Packet Data Convergence Protocol) layer level. For resource aggregation, a UE in RRC_CONNECTED state is allocated two radio links from two different network nodes that may be connected via a non-ideal backhaul. The first node, Master Node (MN), serves as mobility and signaling anchor and the second node, Secondary Node (SN), provides additional local radio resources for UE. The two resource sets are called as Master Cell Group (MCG, associated with MN) and Secondary Cell Group (SCG, associated with SN). The MN can be either LTE eNB or NR gNB. The SN can be either LTE eNB or NR gNB. The MN and the SN can be the same node.

Dual Connectivity can improve user throughput and mobility robustness, since the users may be connected simultaneously to MCG and SCG, as well as improve load balancing between MCG and SCG resources.

The CHO has been specified for UEs configured with use of Dual Connectivity. Herein, the source MN node (controlling Primary Cell, PCell) sends a handover request to the target MN node (controlling target PCell) which in turn selects a secondary node (controlling target PSCell) and prepares it as part of the CHO preparation. When the CHO execution condition is met, the UE performs access to the target PCell and PSCell.

In the following, several embodiments will be described.

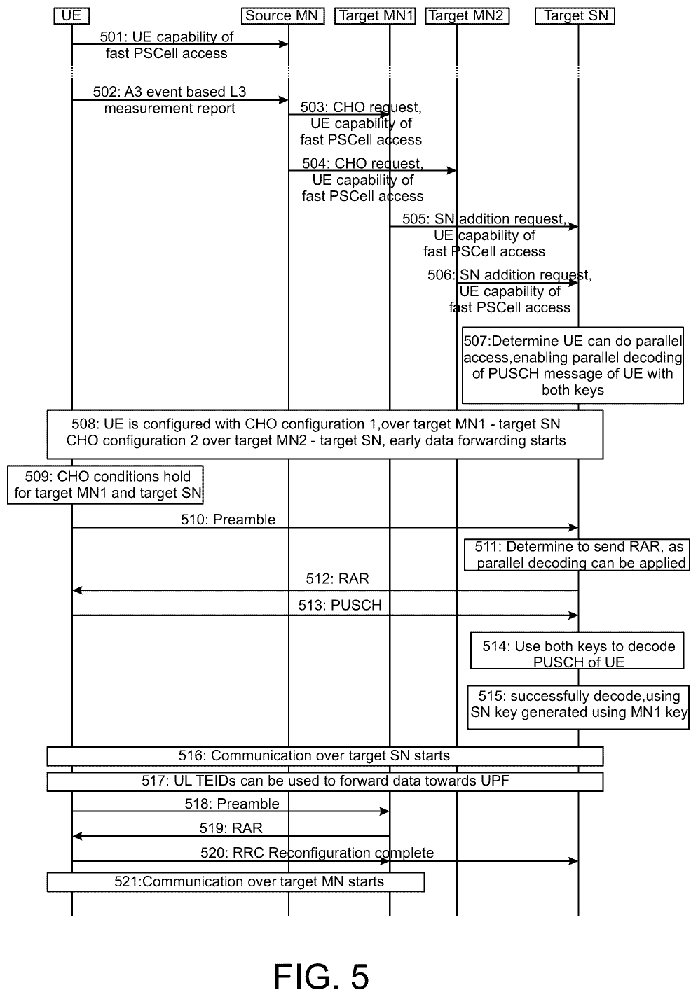

FIG. 5 illustrates a signalling diagram according to an example embodiment. In this example there are two target MNs, namely Target MN 1 and Target MN 2, but in practical implementations the number of target MNs which may take part to the CHO, may be different from two, e.g. more than two. At step 501, the UE indicates the fast PSCell access capability to the serving RAN Node. The fast PSCell access capability is used as a cue by the RAN nodes to initiate a procedure at the network side to successfully achieve fast PSCell access. Especially, this procedure needs to be known at the target SN side, so the capability indication goes from the source MN to the target MN and from the target MN to the target SN.

At steps 502 to 506, once the UE sends a measurement report to trigger a dual connectivity handover (CHO), the source MN includes this capability in the CHO request and furthermore, the target MNs include this capability in the SN addition request message. For each CHO request, the target SN receives different SN security key as the SN key depends on the MN key and each target MN will have its own MN key.

At step 507, the target SN uses the fast PSCell access capability information to determine to trigger the fast PSCell access procedure for the UE.

At step 508, the target SN and the target MN reply to the source SN and the source SN configures the UE with the CHO configuration. In this procedure, the UE may receive two CHO configurations, one for the first target MN (T-MN1) and another one for the second target MN (T-MN2), where each CHO configuration will contain SCG configuration for the same T-SN. As explained in the previous section, T-SN SCG configurations in both CHO config will contain the same CFRA resources configured for the UE. The early data forwarding starts, with early data forwarding the data would be sent from source to the candidate cells, after the initial preparation.

The early data forwarding is done with respect to the target bearer configuration. In early data forwarding, the target SN terminated bearers flow to the target SN and target MN terminated bearers flow to the target MN. This is achieved via configuring the TEIDs of T-SN for target SN terminated bearers.

According to an embodiment, the source MN may forward a copy of all DL data to the first target MN1 and another copy of all DL data to the second target MN2. Once the conditional handover to the first target MN1 or the second target MN2 is accomplished the buffered DL data will be used for DL data transmission from the first target MN1 and/or the second target MN2 to the UE.

Potentially the first target MN1 may decide upon the split of DL data between the first target MN1 and the target SN. Normally, DL data may be forwarded to the target MN and then split and a part of data may be forwarded to the target SN. However, the target MN does not have direct say during early data forwarding. The network can use direct data forwarding using the TEID of the target SN, or it can use indirect data forwarding where the data first goes to the target MN and the target MN forwards the data to the target SN. So, at step 508 the source MN knows about the different split of data and forwards a copy of the first split to the first target MN1, a second split to the target SN, a third split to the second target MN2, and a fourth split to the target SN. The target SN buffers the second and the fourth split till step 515 and the uses e.g. the second split in case of the first target MN1 is detected. Then at step 516 communication with the UE starts and the UE receives DL data from the source MN and in parallel a part of DL data from the target SN.

At step 509, the CHO configuration for the first target MN1 and the target SN holds and the UE initiates the CHO execution.

At step 510, the PRACH occasion for the target PSCell appears first, so the UE sends the preamble to the target PSCell while waiting to transmit the preamble to the target PCell.

At steps 511 and 512, the target SN determines to send the random-access response as the fast PSCell access procedure will be used to resolve the security key ambiguity.

In accordance with an embodiment, the RRCReconfiguration complete may only be sent to the target MN after step 512, as there might be no signalling bearer towards the target SN. For this reason, user plane communication would start towards the target SN.

At step 513, the UE sends the PUSCH message with the resources allocated in a RAR message. The uplink TEIDs towards the user plane function is known at the time of preparation. Moreover, the selected target MN would be known after successful decoding of the UE PUSCH packets. So the data can be forwarded to the right target MN. The UE uses the SN key that corresponds to the first target MN1 CHO configuration since the CHO condition holds for the first target MN1.

At step 514, the target SN employs blind decoding of the PUSCH message using SN keys generated using the key of the first target MN1 and the second target MN2.

At step 515, the target SN successfully decodes the PUSCH message using the SN key generated using the key of the first target MN1.

At A step 516, the answer is sent to the UE and communication over the target SN can start.

At step 517: the UL TEIDs towards the UPF is known at the time of preparation. Moreover, the selected target MN would be known after successful decoding of the UE PUSCH packets. So the data can be forwarded to the right target MN.

At steps 518 to 521, the access to target PCell is completed in the meantime and the RRCReconfiguration complete is sent to the target MN and to the target SN.

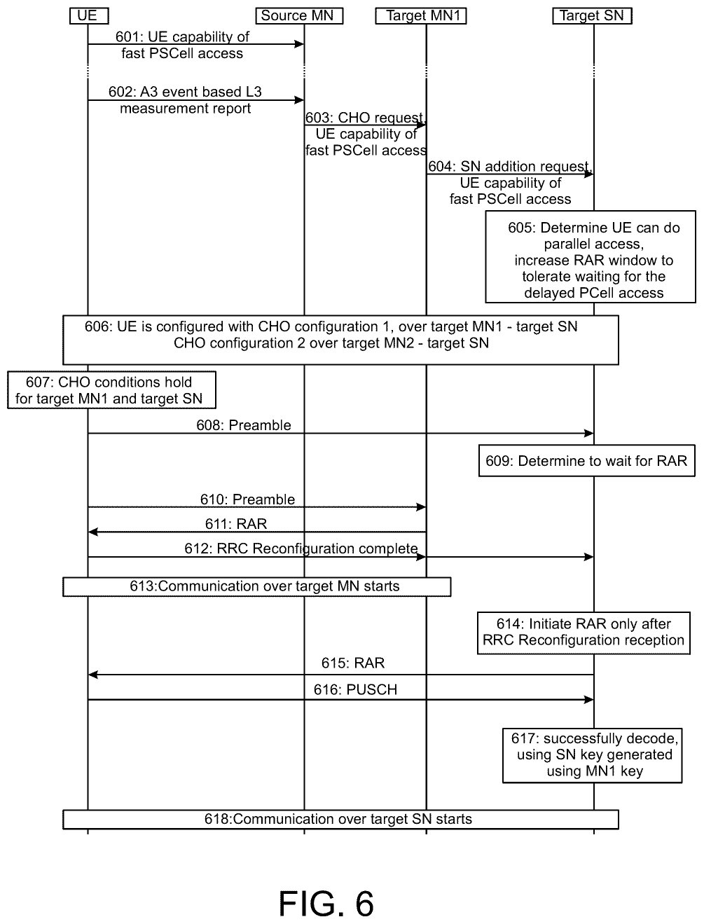

FIG. 6 illustrates a signalling diagram according to another example embodiment, in which a delayed CFRA answer is utilized. Similar to the embodiment of FIG. 5, the UE indicates at step 601 the fast PSCell access capability to the serving RAN Node. The fast PSCell access capability is used as a cue by the RAN nodes to initiate a procedure at the network side to successfully achieve fast PSCell access. Especially, this procedure needs to be known at the target SN side, so the capability indication goes from the source MN to the target MN and from the target MN to the target SN.

Once the UE sends a measurement report at step 602 to trigger a dual connectivity handover (CHO), the source MN includes at step 603 this capability in the CHO request and furthermore, the target MN includes this capability in the SN addition request message and sends it at step 604 to the target SN.

The target MN also configures a RAR timer, that allows enough time for RAR timer of the target SN. For instance, if the target SN RAR timer is a maximum of 1000 ms, the target MN RAR timer should be less than the maximum value (i.e. less than 1000 ms) to allow the target SN to send the RAR after successful completion of the RA procedure in the target MN. Alternatively, the target MN configures the RAR window and indicates it to the target SN in an SN addition request, the target SN then would configure the UE with a RAR window large enough to incorporate the MN RAR duration.

At step 605, the target SN uses the received information to determine to trigger the enhanced random-access procedure for the UE. Furthermore, the target SN configures an extended RAR timer, considering the RAR timer configured by the PCell.

The target MN would know the target SN RAR window and the target MN can allocate the RAR window with respect to what the target SN has allocated. This would allow the UE to complete the MN RAR procedure in time.

At step 606, the target SN and target MN replies to the source and source configures the UE with the CHO configuration.

The CHO configuration for the first target MN1 and the target SN holds and the UE initiates the CHO execution at step 607.

The PRACH occasion for the target PSCell (the target SN) appears first, so the UE sends at step 608 the preamble to the target PSCell while waiting to transmit the preamble to the target PCell (the first target MN1).

At step 609, the target SN determines to wait to send the random-access response as the UE is configured with an extended RAR timer.

In the meantime, at steps 610-612, the access to the target Pcell is completed and the RRC Reconfiguration complete message is sent to the first target MN1 and to the target SN.

At step 613, communication over the target MN may start.

At step 614, the target SN initiates the RAR after receiving RRC Reconfiguration complete message from the first target MN1.

At step 615, the target SN sends the RAR to the UE.

At step 616, the UE sends the PUSCH message with the resources allocated in RAR message.

At step 617, the target SN successfully decodes the PUSCH message using the SN key generated using key of MN1. The answer is sent to the UE and communication over the target SN may start at step 618.

If the UE is capable of working with different RAR windows, e.g. RAR windows for the source MN, the source SN, the target MN, and the target SN, cell group specific RACH configuration could be used, e.g. a RA-response Window is the parameter configured there. An example of such configuration is as follows:

ra-Response Window ENUMERATED {sl1, sl2, sl4, sl8, sl10, sl20, sl40, sl80}

An embodiment comprises assigning a RAR window large enough to cover both the RAR window of the first target MN1 and the second target MN2 by, e.g., the target SN.

According to an embodiment, when the target SN receives a second SN addition request from a second target MN, but for the same UE, to assign one extended RAR window, which is then used in step 509, the value of the extended RAR window should to be chosen to be larger than RAR windows of the first target MN1, the second target MN2 and the target SN.

It should be noted that the UE will not do access to the first target MN1 and the second target MN2 at the same time. It will select one of them.

The extended RAR window values are communicated to the UE in step 506, so then the UE would be enabled to wait for step 514 RAR longer than usual, but in case of failure the UE may need to resend RACH preamble which will then be delayed.

Without extended RAR window, the PSCell access towards target SN will fail as the UE cannot receive RAR within the RAR window, if the PCell access is not completed within the RAR window.

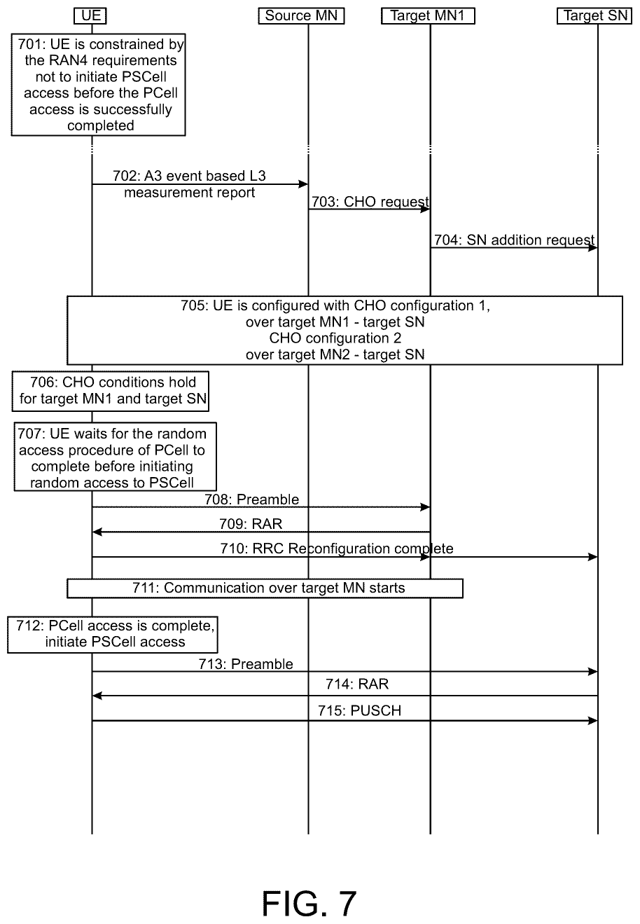

FIG. 7 illustrates a signalling diagram according to yet another example embodiment. At step 701, the UE is constraint by RAN4 requirements to not initiate PSCell access unless PCell access is completed during a dual connectivity handover for CHO with multiple candidate SCGs.

At step 702, the UE sends a measurement report to trigger a dual connectivity handover (CHO) to the source MN. Then, at step 703, the source MN includes this capability to a CHO request and sends it to the first target MN1.

At step 704, the target MN sends a SN addition request to the target SN to maintain dual connectivity for the UE.

At step 705, the target SN and the target MN reply to the source MN and the source MN configures the UE with the CHO configuration.

At step 706, the CHO configuration for the target MN1 and the target SN holds and the UE initiates the CHO execution.

It is now assumed that the PRACH occasion for the target PSCell appears first. Therefore, even thought that is the case the UE cannot initiate an access to the PSCell as it is constrained, so, at step 707, the UE waits for the random-access procedure of the PCell to complete before initiating a random-access to the PSCell.

In the meantime, the access to target PCell is completed. This may have been accomplished so that at step 708, the UE sends a preamble to the target Pcell and at step 709 the target Pcell replies by sending the RAR to the UE. At step 710 the RRCReconfiguration complete message is sent from the UE to the target MN and to the target SN.

After sending the RRCREconfiguration complete message to the target SN, communication over the target MN may start at step 711 and the UE determines at step 712 that the Pcell access is complete and initiates the PSCell access procedure. In other words, once the UE is able to transmit the RRCREconfigurationComplete towards the PCell, after successful acknowledging of the RRCRecconfigurationcomplete then the UE sends the preamble towards the PSCell.

At step 713, the UE sends the preamble to the target PSCell.

At step 714, the target SN sends the random-access response to the UE.

At step 715, the UE sends the PUSCH message with the resources allocated in RAR message to the target PSCell.

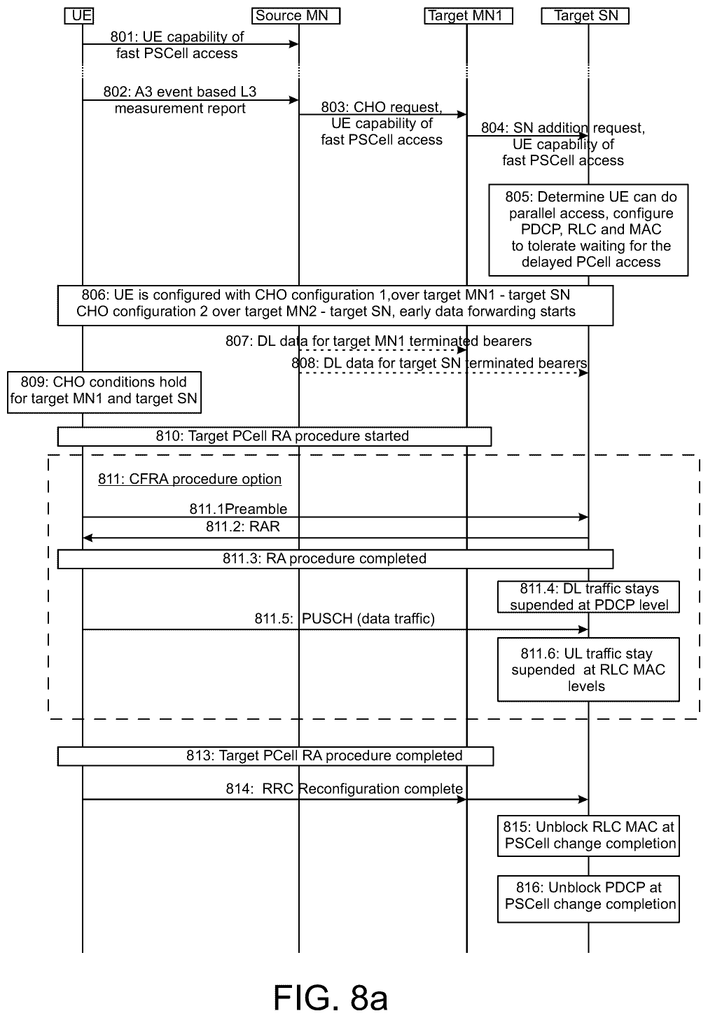

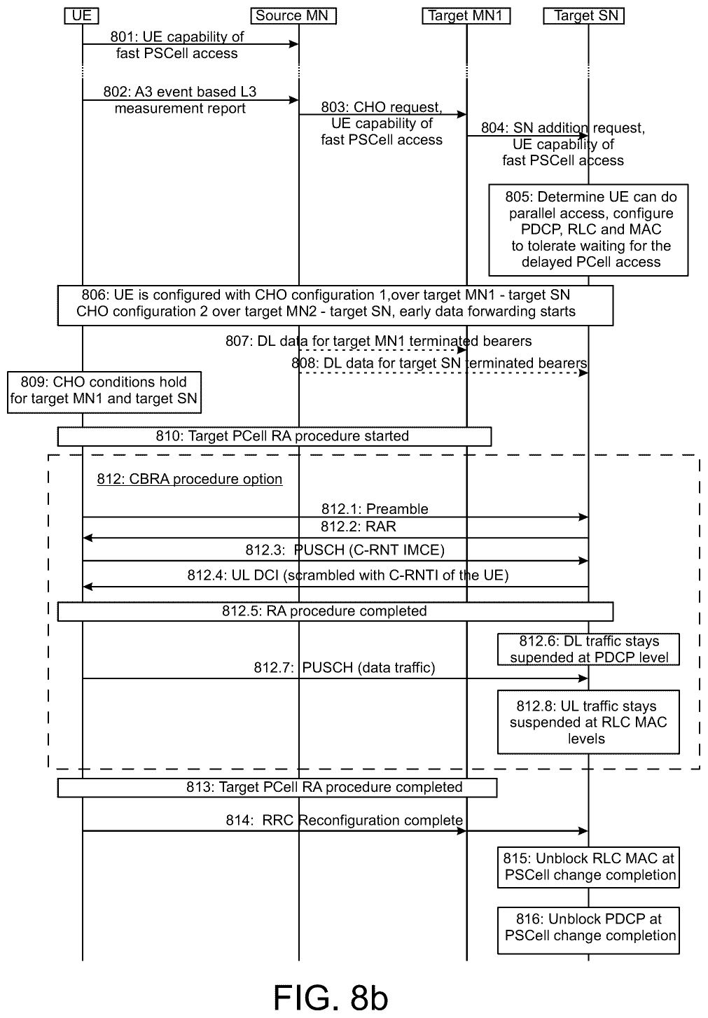

In the following, another embodiment will be described with reference to FIG. 8a illustrated as a signalling diagram based on a CFRA procedure and FIG. 8b illustrated as a signalling diagram based on a CBRA procedure. It is assumed that the UE is capable of parallel synchronization with the target PCell and the target PSCell. Random-access procedures to the target PCell and the target PSCell can be performed in parallel. It is also assumed that CHO/CPC conditions holds for both the target PCell and the target PSCell. Parallel synchronization with target PCell and target PSCell is started and the random-access procedure to the target PSCell is completed before the target PCell is ready (i.e. the CHO is not completed successfully, yet).

At steps 801-804, the UE declares to be capable of performing parallel access to the target PCell and to the target PSCell. Information is propagated in a CHO request to the target MN1 and then to the target SN in an SN addition request.

At step 805, the target PSCell shall assign the resources in regular way but it shall indicate to PDCP (E1AP) that DL traffic shall be put on hold. Neither ciphering nor integrity protection can be applied. PDCP PDUs shall not be forwarded to lower layer (RLC) for transmission and buffered instead. Discard timers shall not be started. Target PSCell shall indicate to MAC (F1AP) to refrain from UL scheduling (except UL scheduling related to RA procedure i.e. RAR and—in case of CBRA—UL DCI related to the completion of contention resolution procedure) including ignoring of positive SRI transmissions from the UE. Target PSCell shall indicate to RLC (F1AP) that UL traffic shall not be forwarded to higher layer (PDCP) for further processing and buffered, instead.

At step 806, the UE is configured with CHO configuration in legacy way (target MN+target SN) and early data forwarding starts as is illustrated with steps 807 and 808.

At step 807, possible downlink data may be communicated for target MN1 terminated bearers and, at step 808, the downlink data may be communicated for target SN terminated bearers.

At step 513 of FIG. 5 a PUSCH is sent to initiate user plane communication.

The focus of FIG. 5 is to try to decode any PUSCH received via all configured keys, e.g. all target MNs prepared for the specific target SN. The UL TEIDs towards the UPF is known at the time of preparation. Moreover, the selected target MN would be known after successful decoding of the UE PUSCH packets.

The UE starts CHO evaluation phase. At some point in time, it appears that CHO condition holds for target MN1 and target SN (step 809).

At steps 810 and 813, the UE performs the random-access procedure for the target MN (target PCell). In the examples of FIGS. 8a and 8b, the random-access procedure for the target MN lasts for longer than the random-access procedure started by the UE in parallel for the target SN (the target PSCell).

The steps at 811 (811.1-811.6) illustrate the option for the CFRA procedure.

At steps 811.1-811.2, the UE transmits a preamble over PRACH to the target SN and receives RAR successfully from the target SN.

At step 811.3, the random-access procedure is completed successfully from both the UE and the target SN (the target PSCell) perspective.

At step 811.4, any downlink (DL) traffic which appears at the PDCP level is buffered as was configured in step 805.

At step 811.5, the UE uses a RAR grant to send traffic, but the traffic stays buffered at the RLC level as was configured in step 805. It should be noted that the MAC should confirm the transmission by sending a TBS 0 grant for the same HARQ process. It should also be noted that the RLC should be ready for an ARQ status transmission if requested and the ARQ status is allowed to be sent. Also a PUCCH transmission should be allowed, but a positive SRI transmission shall be ignored, however.

At step 813, the random-access procedure at the target MN (target PCell) completes successfully. The UE sends at step 814 the RRCReconfigurationComplete message to the target PCell with embedded SN-dedicated RRCReconfigurationComplete message which is forwarded by the target MN to the target SN (target PSCell). It indicates that PSCell change completion process can be started.

At step 815, the target PSCell shall indicate to MAC (F1AP) that UL scheduling shall be unblocked and positive SRI transmissions shall be processed normally. The target PSCell shall indicate to the RLC (F1AP) that UL traffic shall be treated normally. Forwarding to a higher layer (PDCP) is allowed.

At step 816, the target PSCell indicates to the PDCP (E1AP) that DL traffic shall be treated normally (once security context is known). Discard timers shall be started. PDCP shall be allowed to forward data to lower layer (RLC) for transmission.

Next, the CBRA procedure will be described with reference to FIG. 8b, especially the steps at 812 (812.1-812.8). The steps 801 to 810 are similar to the steps 801 to 810 of the CFRA option depicted in FIG. 8a, hence the description of these steps is omitted here.

At steps 812.1 and 812.2, the UE transmits a preamble to the target SN over PRACH and receives RAR successfully from the target SN.

At steps 812.3 and 812.4, the UE transmits a C-RNTI MCE to the target SN using a RAR grant and receives a UL DCI scrambled with its own C-RNTI from the target SN.

At step 812.5, the random-access procedure is completed from both the UE and the target SN (target PSCell) perspective.

At step 812.6, the DL traffic which may appear at PDCP level is buffered as configured in step 805.

At step 812.7, the UE uses an uplink (UL) DCI related to contention resolution completion to send traffic, but the traffic stays buffered (step 812.8) at RLC level as configured in step 805. It should be noted that the MAC should confirm the transmission by sending the TBS 0 grant for the same HARQ process and that the RLC should be ready for ARQ status transmission if requested (ARQ status is allowed to be sent). PUCCH transmission should also be allowed, but a positive SRI transmission shall be ignored, however.

Now, the procedure continues at step 813 in the same way than in the CFRA option of FIG. 8a.

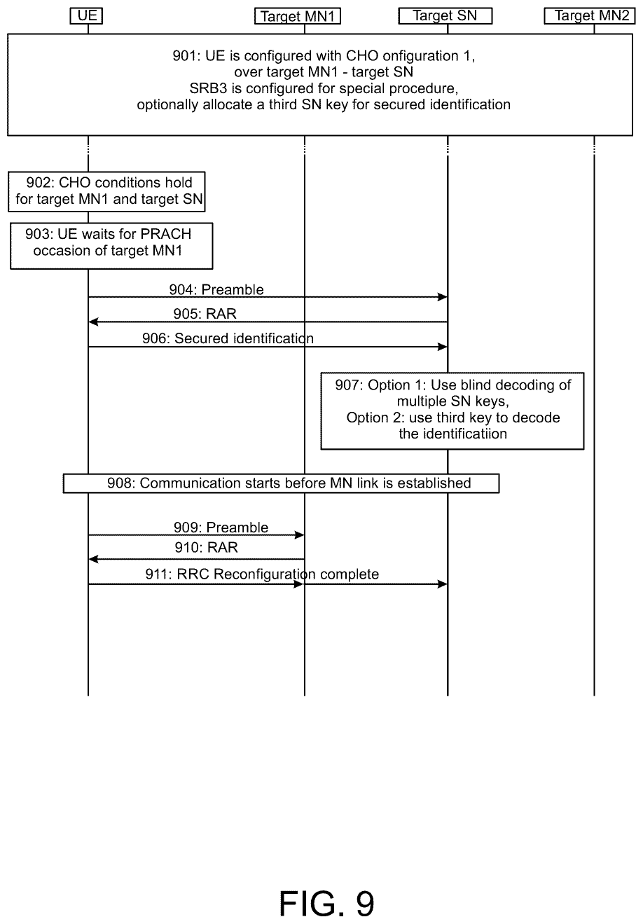

In another solution with extra security procedure at target SN side, illustrated in FIG. 9, the UE is configured at step 901 with a signalling radio bearer 3 (SRB3), which is implemented for specific RRC messages when the UE is in EN-DC (E-UTRAN Now Radio Dual Connectivity), all using DCCH logical channel for dual connectivity handover operation. During the SRB3 configuration, UE may be allocated a separate (e.g. a third) identification key by the target SN.

At step 904, the UE sends a preamble to the target PCell and at step 905 the target PCell replies by sending the RAR to the UE.

At step 906, the configuration of SRB3 allows the UE to send a secured identification message directly to the target SN to resolve the security issue. The secured identification can be an SN RRCReconfiguration complete message. This message can be a lighter message carrying an encrypted UE identification message.

The UE sends this indication as a result of successful application of the target RRCreconfiguration. Otherwise, it refrains from this indication. The target SN can use, if allocated, the third identification key to decode the secured identification message from the UE, or the target SN should use blind decoding (step 907) using the key allocated over target MN1 and target MN2.

Afterwards the SN link communication can start (step 908) and UE may experience lower interruption time compared to sequential access.

At step 909, the UE sends the preamble to the target PSCell.

At step 910, the target SN sends the random-access response to the UE.

At step 911, the RRCReconfiguration complete message is sent from the UE to the target MN1 and the target SN.

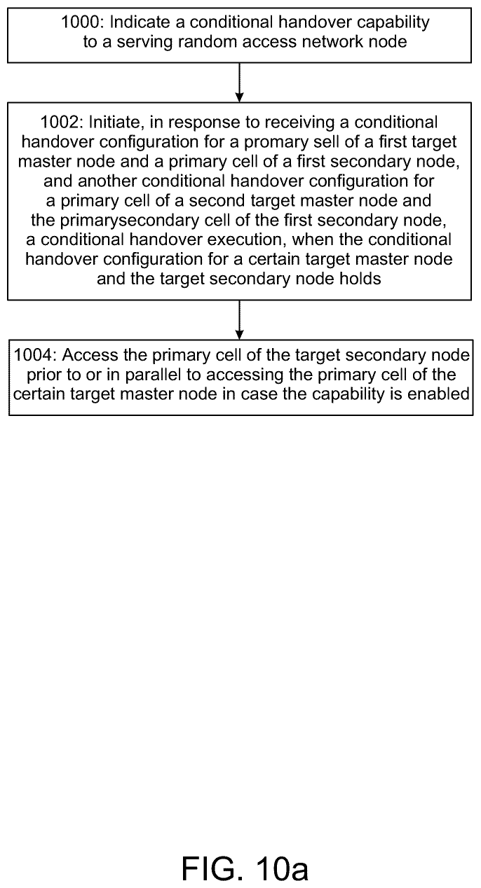

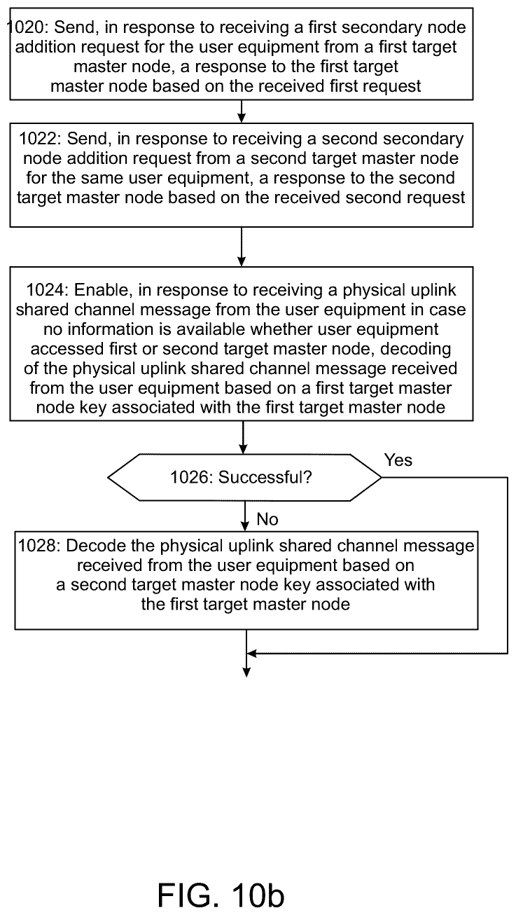

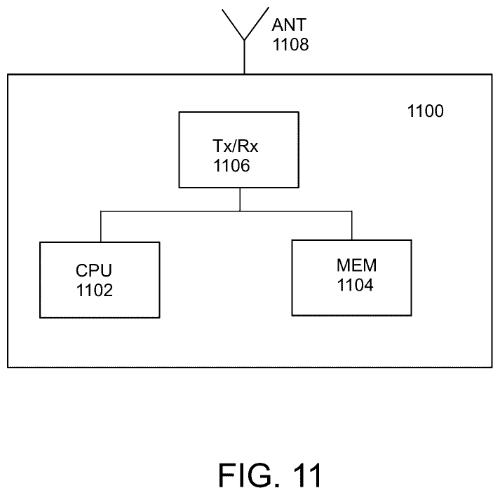

A method for conditional handover will be described with reference to the flow diagram of FIGS. 10a and 10b, in accordance with an embodiment.

In accordance with an embodiment, the conditional handover capability is disabled in response to receiving an indication that the secondary node does not support blind or parallel decoding or stopping of user plane transmission of the user equipment, or if the user equipment cannot be configured with the SRB3 for security indication.

In accordance with an embodiment, a security indication may be sent using a security key from the user equipment to the target secondary node, wherein the security indication is a secondary node key or a specific key used for identification purpose.

In accordance with an embodiment, the UE capability may be enabled by a serving network node, e.g. a master node, e.g. included in a conditional handover configuration, and e.g. based on feedback from target master node(s) and/or secondary node. For example, the secondary node may not support blind/parallel decoding, then if the UE supports fast SN access, but the network not, the UE may be remotely configured to complete access to target master node first, before accessing SN. This may be a default configuration by the network, or e.g. disabling the UE capability by e.g. information included in the CHO configuration. Hence, the RACH preamble and the RAR message may be optional, e.g. access in case of timing advance info already available in the UE may start with RRCReconfigComplete or PUSCH, or else.” In this context, the term “fast access” means, for example, that accessing target SN, and starting data communication, may occur before accessing the target MN by the UE.

The flow diagram of FIG. 10a reflects the operation of a UE, and the flow diagram of FIG. 10b reflects the operation of a target SN, such as a gNB.

At the UE, the method comprises indicating (1000) a conditional handover capability to a serving random access network node; in response to receiving a conditional handover configuration for a primary cell of a first target master node and a primary cell of a first secondary node, and another conditional handover configuration for a primary cell of a second target master node and the primary secondary cell of the first secondary node; initiating (1002) a conditional handover execution, when the conditional handover configuration for a certain target master node and the target secondary node holds; and accessing (1004) the primary cell of the target secondary node prior to or in parallel to accessing the primary cell of the certain target master node in case the capability is enable.

At the target secondary node of a radio access network, the method comprises in response to receiving a first secondary node addition request for the user equipment from a first target master node, sending (1020) a response to the first target master node based on the received first request; in response to receiving a second secondary node addition request from a second target master node for the same user equipment, sending (1022) a response to the second target master node based on the received second request; and in response to receiving a physical uplink shared channel message from the user equipment enabling (1024), in case no information is available whether user equipment accessed first or second target master node, decoding of the physical uplink shared channel message received from the user equipment based on a first target master node key associated with the first target master node and, if (1026) decoding with the first target master node key is not successful, based on a second target master node key (1028) associated with the second target master node.

The method and the embodiments related thereto may also be implemented in an apparatus implementing an access point or a base station of a radio access network, such as an eNB or a gNB. An apparatus, such as a gNB, according to an aspect comprises means for receiving requests from a plurality of master nodes to be included added as a secondary node into as part of a conditional handover process for a user equipment; means for obtaining, from each of said requests, an identification of the user equipment involved in the conditional handover process; and means for determining, based on said identifications of the user equipment, that a plurality of said requests concern the same user equipment.

Such apparatuses may comprise e.g. the functional units disclosed in FIG. 9 showing a simplified block diagram of a network node, i.e. the apparatus, according to the aspects and the related embodiments. It is noted that while the above embodiments are mainly disclosed in connection with a target Secondary Node (SN), the structure and functional units as disclosed in FIG. 9 are equally applicable in network node, such as in a source MN, a source SN and a target MN, as disclosed above.

The network node 1100 may be a base station, an access point, an access node, a gNB, a evolved NodeB (eNB), a server, a host, or any other network entity that may communicate with the UE.

The apparatus may include at least one processor or control unit or module 1102. At least one memory 1104 may be provided in the apparatus. The memory may include computer program instructions or computer code contained therein. One or more transceivers 1106 may be provided, and the apparatus may also include an antenna 1108, Although only one antenna each is shown, many antennas and multiple antenna elements may be provided to the apparatus. Other configurations of the apparatus, for example, may be provided. For example, in addition to wireless communication, the network node may be additionally configured for wired communication with the UE, and in such a case antenna 1108 may illustrate any form of communication hardware, without being limited to merely an antenna.

Transceiver 1106 may be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network node deliver local content. One or more functionalities may also be implemented as virtual application(s) in software that can run on a server.

In certain embodiments, the apparatus may comprise at least one processor and at least one memory including computer program code. The at least one memory including computer program code can be configured to, with the at least one processor, cause the apparatus at least to perform any of the processes described herein.

Processors 1102 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). The at least one memory 1104 may independently be any suitable storage device, such as a non-transitory computer-readable medium. A hard disk drive (HDD), random access memory (RAM), flash memory, or other suitable memory may be used. The memory may be combined on a single integrated circuit as the processor, or it may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network node 1100, to perform any of the processes described above. Therefore, in certain embodiments, a non-transitory computer-readable medium may be encoded with instructions or one or more computer program (such as added or updated software routine, applet or macro) that, when executed in hardware, may perform a process such as one of the processes described herein. In other embodiments, a computer program product may encode instructions for performing any of the processes described above, or a computer program product embodied in a non-transitory computer-readable medium and encoding instructions that, when executed in hardware, perform any of the processes describes above. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

According to an embodiment, a computer program comprises instructions stored thereon for causing an apparatus to perform at least the following: receive an addition request from a target master node with an indication that the request refers to a conditional handover, said request comprising an identifier of a user equipment and an identifier of a source master node; use the identifier of the user equipment and the identifier of the source master node to check, if the apparatus has a controlling target primary cell prepared for this user equipment; compare an existing secondary group configuration with a secondary group configuration included in the request; verify, based on the comparison, that a same data radio bearer can be allocated for the addition request; and respond to the request with an identifier of a tunnel endpoint for downlink data forwarding, which have already been allocated for a previous addition request.

According to an embodiment, a computer program comprises instructions stored thereon for causing an apparatus to perform at least the following: receive a tunnel endpoint identifier of a first target master node and a first target tunnel endpoint identifier from the first target master node; receive a tunnel endpoint identifier of a second target master node and a second target tunnel endpoint identifier from the second target master node; determine that the first target tunnel endpoint identifier and the second target tunnel endpoint identifier correspond with each other; and decide to send data addressed to a target secondary node via only one of the first target master node and the second target master node.

According to an embodiment, a computer program comprises instructions stored thereon for causing an apparatus to perform at least the following: send an addition request related to a conditional handover to a target secondary node, the addition request comprising information of requested secondary cell group bearer configuration and information of identity of a user equipment; receive an addition request acknowledgement from the target secondary node, the addition request acknowledgement comprising a secondary cell group configuration and an indication that an identifier of a tunnel endpoint allocated by the target secondary node for downlink data is shared with another target master node; based on the indication decide to use indirect data forwarding; and send an identifier of a tunnel endpoint of the apparatus and the shared identifier of the tunnel endpoint allocated by the target secondary node for downlink data to a source master node.

In certain embodiments, an apparatus may include circuitry configured to perform any of the processes or functions illustrated above. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

Specific examples of circuitry may be content coding circuitry, content decoding circuitry, processing circuitry, image generation circuitry, data analysis circuitry, or discrete circuitry. The term circuitry may also be, for example, a baseband integrated circuit or processor integrated circuit for a mobile device, a network entity, or a similar integrated circuit in server, a cellular network device, or other computing or network device.

A further aspect relates to a computer program product, stored on a non-transitory memory medium, comprising computer program code, which when executed by at least one processor, causes an apparatus at least to perform: receive requests from a plurality of master nodes to be added as a secondary node as part of a conditional handover process for a user equipment; obtain, from each of said requests, an identification of the user equipment involved in the conditional handover process; and determine, based on said identifications of the user equipment, that a plurality of said requests concern the same user equipment.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. A user equipment comprising at least one processor and at least one memory, said at least one memory stored with computer program code thereon, the at least one memory and the computer program code configured to, with the at least one processor, cause the user equipment at least to perform:
indicating a conditional handover capability towards a serving network node, wherein the capability includes information whether the user equipment supports accessing a primary cell of a secondary cell group of a target secondary node prior to or in parallel to accessing a primary cell of a target master node;
in response to receiving a conditional handover configuration for a primary cell of a first target master node and a primary cell of a first secondary node;
initiating a conditional handover execution, when the conditional handover configuration for a certain target master node and the target secondary node holds; and
accessing the primary cell of the target secondary node prior to or in parallel to accessing the primary cell of the certain target master node in case the capability is enabled.

2. The user equipment according to claim 1, comprising computer program code configured to cause the user equipment to perform:
initiating a conditional handover execution in response to receiving the conditional handover configuration for a primary cell of a first target master node and a primary cell of a first secondary node, and another conditional handover configuration for a primary cell of a second target master node and the primary secondary cell of the first secondary node.

3. The user equipment according to claim 1, comprising computer program code configured to cause the user equipment to perform:
enabling the conditional handover capability based on
an indication in a conditional handover configuration received from a serving network node, that is partially based on an indication of support of fast access to a primary cell of a secondary cell group from
one or more target master nodes or
a secondary node.

4. The user equipment according to claim 3, comprising computer program code configured to cause the user equipment to perform:
disabling the conditional handover capability in response to receiving an indication that the secondary node does not support:
blind or parallel decoding, or
stopping of user plane transmission of the user equipment, or
the user equipment cannot be configured with a signalling radio bearer 3 for security indication.

5. The user equipment according to claim 4, comprising computer program code configured to cause the user equipment to perform:
completing access to the target master node first, before accessing the secondary node.

6. The user equipment according to claim 1, comprising computer program code configured to cause the user equipment to perform:
sending a preamble to the target secondary node while waiting to transmit the preamble to a target master node;
receiving a random-access response from the target secondary node;
sending a physical uplink shared channel message with resources allocated in the random-access response message; and
using the secondary node key that corresponds to the corresponding target master node configuration.

7. The user equipment according to claim 1, comprising computer program code configured to cause the user equipment to perform:
sending a security indication using a security key to the target secondary node, wherein the security indication is
a secondary node key or
a specific key used for identification purpose.

8. The user equipment according to claim 1, comprising computer program code configured to cause the user equipment to perform:
determining, based on the capability, if conditional handover capability is enabled.

9. The user equipment according to claim 8, comprising computer program code configured to cause the user equipment to perform:
in response to the determining, either utilising the conditional handover capability to complete access to the master node and the secondary node in parallel or completing access to the master node first, before accessing the secondary node.

10. A method comprising:
indicating a conditional handover capability to a serving network node, wherein the capability includes information whether the user equipment supports accessing a primary cell of a target secondary node prior to or in parallel to accessing a primary cell of a secondary cell group of a target master node;
in response to receiving a conditional handover configuration for a primary cell of a first target master node and a primary cell of a first secondary node,
initiating a conditional handover execution, when the conditional handover configuration for a certain target master node and the target secondary node holds; and
accessing the primary cell of the target secondary node prior to or in parallel to accessing the primary cell of the certain target master node in case the capability is enabled.

11. A network node for a radio access network, the network node comprising at least one processor and at least one memory, said at least one memory stored with computer program code thereon, the at least one memory and the computer program code configured to, with the at least one processor, cause the network node at least to perform:
in response to receiving a first secondary node addition request for the user equipment from a first target master node, sending a response to the first target master node based on the received first request;
in response to receiving a second secondary node addition request from a second target master node for the same user equipment, sending a response to the second target master node based on the received second request; and
in response to receiving a physical uplink shared channel message from the user equipment enabling, in case no information is available whether user equipment accessed first or second target master node, decoding of the physical uplink shared channel message received from the user equipment based on a first target master node key associated with the first target master node and, if decoding with the first key not successful, based on a second target master node key associated with the second target master node.

12. The network node according to claim 11, comprising computer program code configured to cause the network node to perform:
enabling the conditional handover capability of the user equipment by an indication included in a conditional handover configuration.

13. The network node according to claim 11, comprising computer program code configured to cause the network node to perform:
disabling the conditional handover capability by sending to the user equipment an indication that the network node does not support blind or parallel decoding.

14. The network node according to claim 11, comprising computer program code configured to cause the network node to perform early data forwarding by:
forwarding a copy of all downlink data related to the user equipment to the first target MN1 and another copy of all downlink data related to the user equipment to the second target MN2

15. The network node according to claim 14, comprising computer program code configured to cause the network node to perform early data forwarding by:
using the buffered DL data for downlink data transmission from the first target MN1 and/or the second target MN2 to the user equipment, when the conditional handover to the first target MN1 or the second target MN2 is accomplished.

16. The network node according to claim 14, comprising computer program code configured to cause the network node to perform:
configuring the TEIDs of the target secondary node for target SN terminated bearers.

17. A method comprising:
in response to receiving a first secondary node addition request for the user equipment from a first target master node, sending a response to the first target master node based on the received first request;
in response to receiving a second secondary node addition request from a second target master node for the same user equipment, sending a response to the second target master node based on the received second request; and
in response to receiving a physical uplink shared channel message from the user equipment enabling, in case no information is available whether user equipment accessed first or second target master node, decoding of the physical uplink shared channel message received from the user equipment based on a first target master node key associated with the first target master node and, if decoding with the first key not successful, based on a second target master node key associated with the second target master node.
